(19) United States
(12) Patent Application Publication
(10) Pub. No.: US 2020/0012973 A1
(43) Pub. Date: Jan. 9, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Shinichi OKABE, Nagakute-shi (JP); Hiroaki SAKURAI, Nagoya-shi (JP); Kazuaki TAKEMURA, Nagoya-shi (JP); Kengo TAKEUCHI, Ogaki-shi (JP); Kaori SAKAI, Tokyo-to (JP); Hideo HASEGAWA, Nagoya-shi (JP)

(73) Assignee: TOYOTA JIDOSHA KABUSHIKI KAISHA, Toyota-shi (JP)

(21) Appl. No.: 16/454,825

(22) Filed: Jun. 27, 2019

(30) Foreign Application Priority Data
Jul. 3, 2018 (JP) 2018-126929

(51) Int. Cl. G06Q 10/02; G06Q 50/30; G01C 21/34

(52) U.S. Cl. CPC G06Q 10/025; G01C 21/3438; G06Q 50/30

(57) ABSTRACT

An information processing apparatus includes a processor which executes accepting purchase of a ticket for an event from a first ticket purchaser and, if the first ticket purchaser is to travel to a venue for the event by a vehicle, accepting registration of information on a ride-sharing usage pattern, selecting, as a ride-sharing candidate, a second ticket purchaser which conforms to the ride-sharing usage pattern for the first ticket purchaser from among ticket purchasers which have purchased tickets for the event or a similar event partially identical in venue and period to the event, and presenting the second ticket purchaser to the first ticket purchaser.

### CROSS REFERENCE TO RELATED APPLICATION

This application claims the benefit of Japanese Patent Application No. 2018-126929, filed on Jul. 3, 2018, which is hereby incorporated by reference herein in its entirety.

### BACKGROUND

### Technical Field

The present disclosure relates to an information processing apparatus and an information processing method for supporting ride-sharing matching.

### Description of the Related Art

A form of traveling in which a plurality of users share a ride (ride-share) in the same vehicle has become widespread in these years. For the form of traveling, Patent Document 1 presents a technique for dispatching a ride-sharing taxi for a customer, among customers which have reservations on a flight, which is to take a taxi from a place of arrival of the flight to a final destination. Patent Document 2 presents a technique for selecting a ride-sharer which is high in the degree of coincidence in basic attributes, purchase behavior, or geographical conditions with a customer and searching for a ride-sharer which gives little sense of resistance.

### CITATION LIST

### Patent Document

Patent document 1: Japanese Patent Laid-Open No. 2004-220396

Patent document 2: Japanese Patent Laid-Open No. 2015-076028

If ride-sharing and traveling to a venue is desired to attend an event or the like, there is the problem of having time and trouble searching for a ride partner. Under the circumstances, it is an object of the present disclosure to save the time and trouble of searching for a ride partner and promote vehicle ride-sharing.

### SUMMARY

An information processing apparatus according to a first aspect of the present disclosure includes

a processor configured to:

accept purchase of a ticket for an event from a first ticket purchaser and, when the first ticket purchaser is to travel to a venue for the event by a vehicle, accept registration of information on a ride-sharing usage pattern;

select, as a ride-sharing candidate, a second ticket purchaser which conforms to the ride-sharing usage pattern for the first ticket purchaser from among ticket purchasers which have purchased tickets for the event or a similar event partially identical in venue and period to the event; and

present the second ticket purchaser to the first ticket purchaser.

An information processing method according to a second aspect of the present disclosure is an information processing method for causing a computer to execute:

accepting purchase of a ticket for an event from a first ticket purchaser and, when the first ticket purchaser is to travel to a venue for the event by a vehicle, accepting registration of information on a ride-sharing usage pattern;

selecting, as a ride-sharing candidate, a second ticket purchaser which conforms to the ride-sharing usage pattern for the first ticket purchaser from among ticket purchasers which have purchased tickets for the event or a similar event partially identical in venue and period to the event; and

presenting the second ticket purchaser to the ticket purchaser.

A third aspect of the present disclosure is a program for causing a computer to execute the information processing method according to the above-described second aspect or a computer-readable storage medium non-transitorily storing the program.

According to the present disclosure, it is possible to save the time and trouble of searching for a ride partner and promote vehicle ride-sharing.

### BRIEF DESCRIPTION OF DRAWINGS

FIG. 1 is a diagram illustrating schematic configurations of a server and a terminal;

FIG. 2 is a diagram illustrating a functional configuration of the server;

FIG. 3 is an example of an event information table;

FIG. 4 is an example of a purchaser information table according to the first embodiment;

FIG. 5 is an example of a ride-sharing information table according to the first embodiment;

FIG. 6 is an example of a flowchart illustrating the flow of a matching process at the time of ticket purchase according to the first embodiment;

FIG. 7 is an example of a flowchart illustrating the flow of a ride-sharing candidate narrowing-down process according to the first modification;

FIG. 8 is an example of a flowchart illustrating the flow of a ride-sharing candidate narrowing-down process according to the second modification;

FIG. 9 is an example of a purchaser information table according to the second embodiment;

FIG. 10 is an example of a ride-sharing information table according to the second embodiment;

FIG. 11 is an example of a flowchart illustrating the flow of a matching process at the time of ticket purchase according to the second embodiment.

### DESCRIPTION OF THE EMBODIMENTS

An information processing apparatus according to the first aspect of the present disclosure accepts purchase of a ticket for an event from a ticket purchaser and, if the ticket purchaser is to travel to a venue for the event by a vehicle, accepts registration of information on a ride-sharing usage pattern. Sometimes, a ticket purchaser for an event, such as a concert, a sports event, or a festival, uses a vehicle for transportation to a venue for the event. If the ticket purchaser travels by a vehicle, there is the potential that the ticket purchaser desires ride-sharing that means that a plurality of people ride together in one vehicle. The information on the ride-sharing usage pattern is information used to select a ride-sharing candidate to be presented to the ticket purchaser and includes information on whether the ticket purchaser desires ride-sharing. More specifically, the information on the ride-sharing usage pattern can include information on whether the ticket purchaser desires to accept a different ticket purchaser riding together in a vehicle provided by the ticket purchaser itself or whether the ticket purchaser desires to ride together in a vehicle provided by a different ticket purchaser. The information on the ride-sharing usage pattern may include information on the capability of vehicle provision and the capability of driving.

The above-described information processing apparatus selects a ride-sharing candidate which conforms to the ride-sharing usage pattern for the ticket purchaser from among different ticket purchasers which have purchased tickets for the event or a similar event partially identical in venue and period to the event. The ticket purchaser (corresponding to a “first ticket purchaser”) is a person which purchases the ticket for the event and registers the information on the ride-sharing usage pattern. The ride-sharing candidate (corresponding to a “second ticket purchaser”) is a person which is selected as a candidate for ride-sharing with the ticket purchaser from among different ticket purchasers which have already purchased tickets and desire ride-sharing. Assume that the ride-sharing candidate has information on a ride-sharing usage pattern registered at the time of ticket purchase. The ride-sharing candidate that conforms to the ride-sharing usage pattern for the ticket purchaser is, for example, selected from among different ticket purchasers which desire to accept a ride partner if the ticket purchaser desires to be given a ride for ride-sharing and selected from among different ticket purchasers which desire to be given a ride for ride-sharing if the ticket purchaser desires to accept ride-sharing. The ride-sharing candidate that conforms to the ride-sharing usage pattern for the ticket purchaser may be selected on the basis of the capability of vehicle provision and the capability of driving.

If different events are partially identical in venue and period, it is conceivable that ticket purchasers for the different events ride-share and travel. For this reason, a ticket purchaser for a similar event partially identical in venue and period to an event can be included on a list of candidates which are targets for ride-sharing. This allows the information processing apparatus to provide a wide range of ride-sharing candidates to a ticket purchaser.

The above-described information processing apparatus presents a selected ride-sharing candidate to a ticket purchaser. The information processing apparatus may present a plurality of ride-sharing candidates to a ticket purchaser. The information processing apparatus can present a ride-sharing candidate to a ticket purchaser by notifying the ticket purchaser of contact information of the ride-sharing candidate or directing the ticket purchaser to a predetermined application which provides a ride-sharing broking service.

That is, the information processing apparatus according to the first aspect of the present disclosure allows a ticket purchaser for an event or the like to save the time and trouble of searching for a ride partner and allows promotion of vehicle ride-sharing.

Specific embodiments of the present disclosure will be described below with reference to the drawings. The embodiments illustrated below are merely illustrative, and the technical scope of the present disclosure is not limited to the aspects below.

### First Embodiment

A first embodiment of the present disclosure is an information processing apparatus which collects information on a ride-sharing usage pattern via a terminal of a ticket purchaser at the time of selling a ticket for an event or the like and presents matching between purchasers. The matching refers to broking ride-sharing in accordance with a ride-sharing usage pattern, such as the presence or absence of a desire for ride-sharing, the capability of vehicle provision, and the capability of driving.

[Configuration]

(Hardware Configuration)

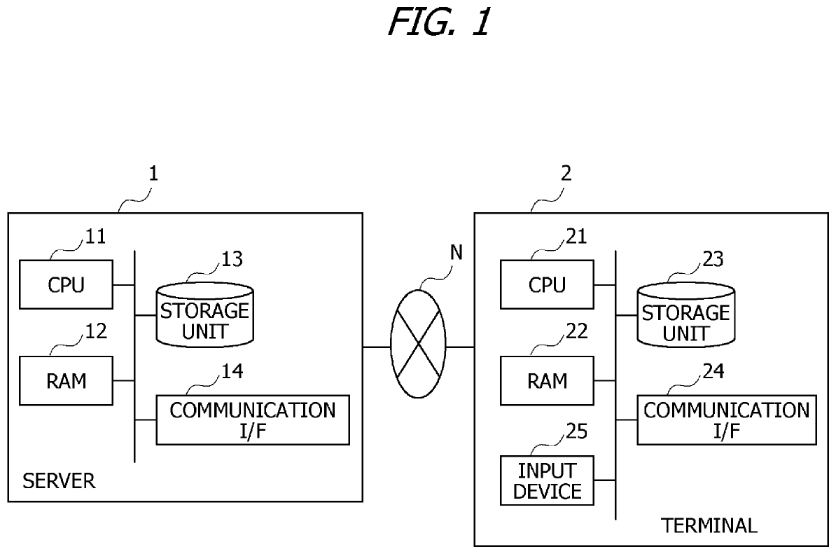

FIG. 1 is a diagram illustrating schematic configurations of a server and a terminal. A server 1 according to the first embodiment is a computer which is installed by a ticket seller for an event or the like and is intended to provide a service, such as ticket selling. The server 1 has a general computer configuration and is connected to a terminal 2 via a network N. The server 1 includes a CPU (Central Processing Unit) 11, a RAM (Random Access Memory) 12, a storage unit 13, and a communication interface (I/F) 14. The server 1 is an example of an “information processing apparatus.” The CPU 11 is an example of a “processor.”

The CPU 11 is a central processing device, and controls the RAM 12, the storage unit 13, and the like by processing instructions and data in various programs loaded on the RAM 12 and the like. Note that the server 1 may be implemented by a dedicated processor, a dedicated circuit, or the like instead of a general-purpose processor, such as the CPU 11.

The RAM 12 is a main memory. Various instructions and data are written to and read from the RAM 12 under control of the CPU 11. The storage unit 13 is a non-volatile memory unit. Information needed to be permanent, such as various programs to be loaded onto the RAM 12, is written to and read from the storage unit 13. The storage unit 13 is, for example, an EEPROM (Electrically Erasable Programmable Read-Only Memory), an HDD (Hard Disk Drive), or the like. The communication interface 14 is an interface for connecting to the Internet that is a worldwide public packet communication network or any other communication network via a gateway or the like.

The terminal 2 is a terminal for a ticket purchaser or a different ticket purchaser which can be a ride-sharing candidate to purchase a ticket or enter information on a ride-sharing usage pattern. The number of terminals 2 is not limited to one, and a plurality of terminals 2 may be connected to the server 1 via the network N. The terminal 2 is, for example, a small-size computer, such as a smartphone, a mobile phone, a tablet terminal, a personal information terminal, or a wearable computer (e.g., a smartwatch). The terminal 2 may be a personal computer (PC) which is connected to the server 1 via the network N or a kiosk terminal which is installed in a convenience store or the like.

The terminal 2 includes a CPU 21, a RAM 22, a memory unit 23, a communication interface (I/F) 24, and an input device 25. Since the CPU 21, the RAM 22, the memory unit 23, and the communication interface 24 are the same as the CPU 11, the RAM 12, the storage unit 13, and the communication interface 14 of the server 1, a description thereof will be omitted. The input device 25 is, for example, a pointing device, such as a touchpad, a mouse, or a touch panel, a keyboard, operation buttons, or the like and accepts operation input. The input device 25 further includes a camera which allows input of pictures and images. The input device 25 can also include a voice input unit, such as a microphone. The input device 25 accepts, from a person which tries to purchase a ticket, operations, such as input of purchaser information and ticket purchase. Information pieces, such as age and gender, of the purchaser information may be acquired through analysis of an image of a purchaser shot by an image pickup device, such as a camera.

The network N is, for example, a worldwide public packet communication network, such as the Internet, and interconnects the server 1 and the terminal 2. Note that a WAN (Wide Area Network) or any other communication network may be adopted as the network N instead of the Internet.

(Functional Configuration)

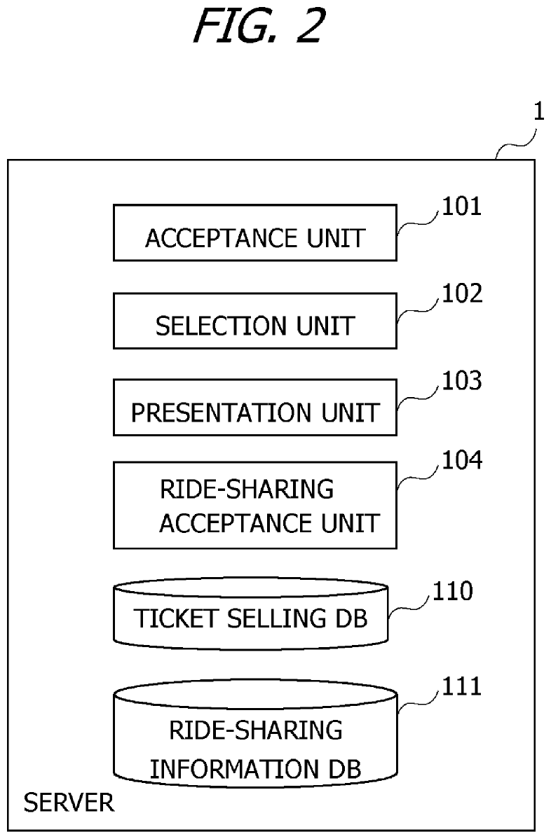

FIG. 2 is a diagram illustrating a functional configuration of the server. The server 1 is installed by, for example, a ticket seller, and a computer which provides a ticket selling site is illustrated as an example. The server 1 includes, as functional components, an acceptance unit 101, a selection unit 102, a presentation unit 103, a ride-sharing acceptance unit 104, a ticket selling database (DB) 110, and a ride-sharing information database (DB) 111. The CPU 11 of the server 1 executes processing by the acceptance unit 101, the selection unit 102, the presentation unit 103, and the ride-sharing acceptance unit 104 by a computer program on the RAM 12. Note that any of the functional components or a part of processing by the functional component may be executed by a hardware circuit.

The ticket selling database 110 and the ride-sharing information database 111 are constructed when a program of a database management system (DBMS) to be executed by the CPU 11 manages data stored in the storage unit 13. The ticket selling database 110 and the ride-sharing information database 111 are, for example, relational databases.

The acceptance unit 101 accepts purchase of a ticket for an event via the terminal 2 of a ticket purchaser. The acceptance unit 101 also accepts registration of information on a ride-sharing usage pattern, such as whether the ticket purchaser desires vehicle ride-sharing to a venue for the event, whether the ticket purchaser is capable of vehicle provision, whether the ticket purchaser is capable of driving, and the like.

If a ticket purchaser desires ride-sharing, the acceptance unit 101 may acquire information on a place of departure where the ticket purchaser is to get into a vehicle. If a ticket purchaser purchases a ticket, the acceptance unit 101 can acquire information on the place of departure from information input to the terminal 2. The acceptance unit 101 may acquire, as information on a place of departure, an address of a ticket purchaser which is registered in advance to purchase a ticket.

If a ticket purchaser which has a purchased ticket for an event desires ride-sharing, the selection unit 102 selects a ride-sharing candidate. The selection unit 102 selects a ride-sharing candidate from among different ticket purchasers for the event, a ticket for which is purchased by the ticket purchaser, or an event similar thereto.

If the acceptance unit 101 acquires information on a place of departure for a ticket purchaser, the selection unit 102 can perform ride-sharing candidate selection such that a distance between the place of departure for the ticket purchaser and a place of departure for a ride-sharing candidate is not more than a predetermined threshold. For example, a distance over which a car can travel in about 15 to 30 minutes is conceived as the predetermined threshold for a distance between places of departure, and the predetermined threshold can be defined so as fall within the 10-20 km range.

Additionally, the selection unit 102 may select a ride-sharing candidate such that the degree of overlap between a first route from a place of departure for a ticket purchaser to a venue for an event and a second route from a place of departure for the ride-sharing candidate to the venue for the event is not less than a predetermined threshold. The selection unit 102 may select a ride-sharing candidate such that the degree of overlap between a first route and a second route is not less than the predetermined threshold, for example, if a place of departure for a ticket purchaser is on the second route or if a place of departure for the ride-sharing candidate is on the first route. For example, the percentage of a distance, by which a first route overlaps with a second route, can be set as the degree of overlap. The predetermined threshold for the degree of overlap can be defined so as to fall within, for example, a range not less than 60%.

The presentation unit 103 presents, to a ticket purchaser, a ride-sharing candidate selected by the selection unit 102. The presentation unit 103 can transmit information on the ride-sharing candidate to the terminal 2 of the ticket purchaser through e-mail or the like or present the information on the ride-sharing candidate to the ticket purchaser via, e.g., an application which provides a ride-sharing broking service.

The ride-sharing acceptance unit 104 accepts, from a ticket purchaser, a request for ride-sharing with a ride-sharing candidate. The ride-sharing acceptance unit 104 transmits details of the request to the terminal 2 of a target candidate which is a target for the request. The details of the request include, for example, information, such as a name of, contact information of, and a place of departure for the ticket purchaser.

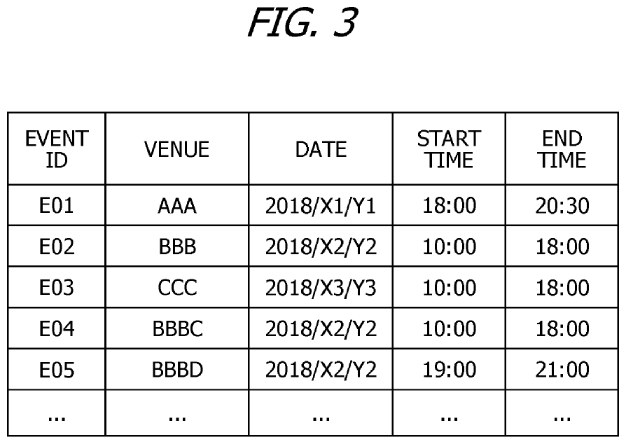

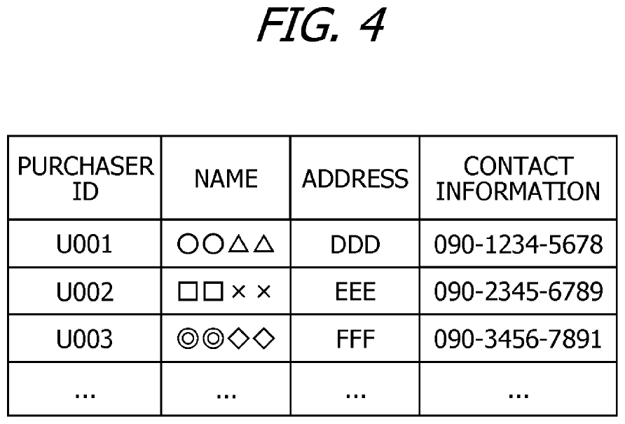

The ticket selling database 110 is a database which stores information on ticket selling. The ticket selling database 110 has an event information table and a purchaser information table. Data structures of the event information table and the purchaser information table will be described with reference to FIGS. 3 and 4. Note that information pieces to be stored in the event information table and the purchaser information table are not limited to examples illustrated in FIGS. 3 and 4 and that a field can be appropriately added, changed, or deleted.

FIG. 3 is an example of an event information table. The event information table is a table for managing an event which is a target for ticket selling. The event information table has fields for event ID, venue, date, start time, and end time. The event ID is an ID for identification of an event and is given by a ticket seller or the like. The event ID is used to, for example, extract a ticket purchaser for the same event when the selection unit 102 selects a ride-sharing candidate.

The venue is a venue for an event and can be specified by, for example, an address, a zip code, or the like. The venue is used to acquire, with the selection unit 102, a similar event partially identical in venue to the event, a ticket for which is purchased by a ticket purchaser. For example, an event, an address of a venue for which includes the same municipality as an address of a venue for the event (a ticket for which is purchased by the ticket purchaser), an event, an address of a venue for which includes the same zip code, or the like can be set as the similar event partially identical in venue. The venue as a destination of ride-sharing is also used to acquire a route from a place of departure for the ticket purchaser or a ride-sharing candidate.

The date is a date when an event is to be held. For an event which is held over a plurality of days, one record may be registered for each date. The start time and the end time are a start time and an end time for the event. The date, the start time, and the end time are used to acquire, with the selection unit 102, a similar event partially identical in period to the event, a ticket for which is purchased by the ticket purchaser.

A start time and an end time are a start time and an end time for an event. The start time and the end time are used to acquire, with the selection unit 102, an event similar to the event, a ticket for which is purchased by a ticket purchaser.

In the example in FIG. 3, an event with an event ID of “E04” (hereinafter referred to as an event E04) has a date of 2018/X2/Y2, a start time of 10:00, and an end time of 18:00, which are the same as that for an event E02. A venue for the event E04 is BBBC and is close to BBB that is a venue for the event E02. In this case, the selection unit 102 can acquire the event E04 as an event similar to the event E02. An event E05 has the same date as the event E02 and has a venue of BBBD, which is close to the venue of BBB for the event E02. A start time and an end time for the event E05, however, are 19:00 and 21:00, respectively, and are different from the start time and the end time for the event E02. In this case, the selection unit 102 can prevent the event E05 from being included on a list of events similar to the event E02. As described above, the selection unit 102 can identify, as a similar event, an event which satisfies predetermined conditions.

FIG. 4 is an example of a purchaser information table according to the first embodiment. The purchaser information table is a table for managing purchaser information acquired from a purchaser at the time of selling of a ticket. The purchaser information table can store, for example, information on a purchaser which is input to the terminal 2 in a user registration procedure at a site which provides a ticket selling service. The purchaser information table has fields for purchaser ID, name, address, and contact information. The purchaser ID is an ID for identification of a purchaser. For example, an ID which is given in a user registration procedure at a ticket selling site can be set as the purchaser ID.

The name is a name of a purchaser and is presented as a name of a ride-sharing candidate to a ticket purchaser by the presentation unit 103. The address is an address of the purchaser and may be used as a place of departure for ride-sharing. The contact information is contact information of the purchaser, and contact information, such as a phone number or a mail address, is stored as the contact information. The contact information may be presented by the presentation unit 103 to the ticket purchaser together with the name of the ride-sharing candidate. The ticket purchaser can use the presented information pieces on the ride-sharing candidate to, e.g., make an offer of ride-sharing to the ride-sharing candidate and adjust a place of departure and a departure time.

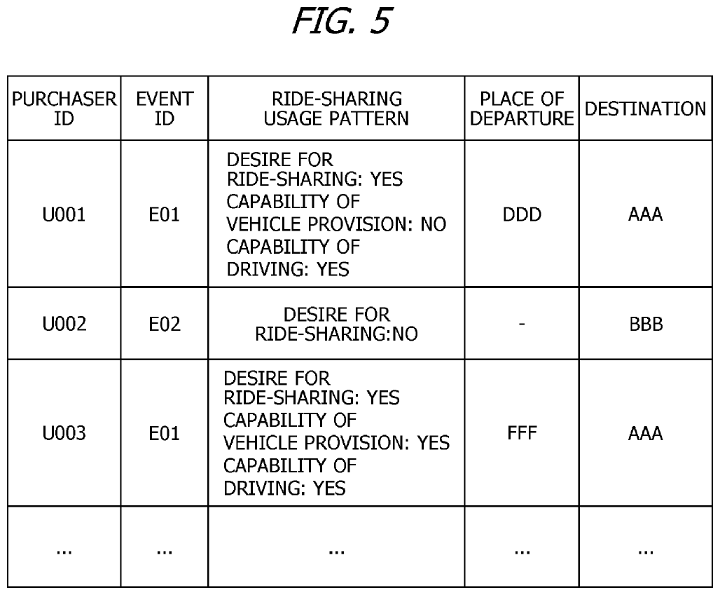

The ride-sharing information database 111 is a database which stores information used for ride-sharing matching. The ride-sharing information database 111 has a ride-sharing information table. A data structure of the ride-sharing information table will be described with reference to FIG. 5. Note that information pieces to be stored in the ride-sharing information table are not limited to examples illustrated in FIG. 5 and that a field can be appropriately added, changed, or deleted.

FIG. 5 is an example of a ride-sharing information table according to the first embodiment. The ride-sharing information table is a table for managing information on ride-sharing for a purchaser. One record in which a purchaser and an event are associated is inserted in the ride-sharing information table when a ticket is purchased. The ride-sharing information table has fields for purchaser ID, event ID, ride-sharing usage pattern, place of departure, and destination.

The purchaser ID is a purchaser ID in the purchaser information table illustrated in FIG. 4, and a purchaser ID for a ticket purchaser which has a purchased ticket for an event is stored as the purchaser ID. The event ID is an event ID in the event information table illustrated in FIG. 3, and an event ID for the event, a ticket for which is purchased by the ticket purchaser, is stored as the event ID.

Information used to match a ticket purchaser with a ride-sharing candidate is stored as a ride-sharing usage pattern. In the example illustrated in FIG. 5, information on whether a ticket purchaser desires ride-sharing, the capability of vehicle provision, and the capability of driving is stored as the ride-sharing usage pattern. Note that the ride-sharing usage pattern may be information which allows the ticket purchaser to be matched with a ride-sharing candidate and is not limited to examples in FIG. 5. Information on whether the ticket purchaser desires to accept a different ticket purchaser riding together in a vehicle provided by the ticket purchaser itself or whether the ticket purchaser desires to ride together in a vehicle provided by a different ticket purchaser may be stored as the ride-sharing usage pattern.

The place of departure is a place of departure in a case where a ticket purchaser desires ride-sharing. The acceptance unit 101 may receive information on a place of departure which is input to the terminal 2 at the time of ticket purchase by the ticket purchaser as information on a usage pattern and store the information in the place-of-departure field of the ride-sharing information table. Alternatively, the acceptance unit 101 may acquire, as the place of departure, an address of the ticket purchaser from the purchaser information table at the time of ticket purchase by the ticket purchaser and store the address in the place-of-departure field of the ride-sharing information table. Additionally, if information on a place of departure or an address is not input to the terminal 2 by the purchaser, the acceptance unit 101 may acquire positional information for the terminal 2 as the place of departure. If the terminal 2 is a kiosk terminal, the acceptance unit 101 can set an address where the kiosk terminal is installed as the place of departure.

The destination is a destination in a case where a ticket purchaser desires ride-sharing. The acceptance unit 101 may receive information on a destination input to the terminal 2 at the time of ticket purchase by the ticket purchaser and store the information in the destination field of the ride-sharing information table. Alternatively, the acceptance unit 101 may acquire a venue for an event as the destination from the event information table at the time of ticket purchase by the ticket purchaser and store the venue in the destination field of the ride-sharing information table.

[Flow of Process]

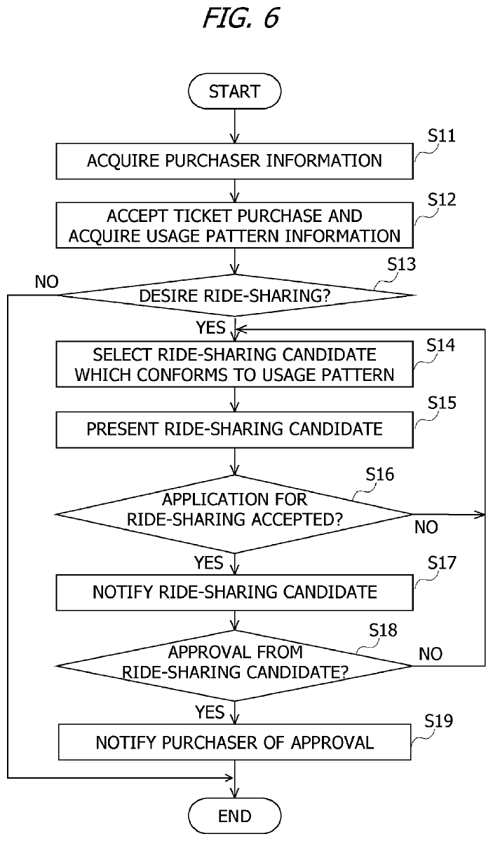

The flow of a process of matching a ticket purchaser with a ride-sharing candidate will be described with reference to FIGS. 6 to 8. A matching process according to the first embodiment selects a ride-sharing candidate from among ticket purchasers for the same event or a similar event on the basis of the presence or absence of a desire for ride-sharing and presents the ride-sharing candidate to a ticket purchaser. The matching process according to the first embodiment also presents a ride-sharing candidate to a ticket purchaser on the basis of a place of departure for the ticket purchaser and a place of departure for the ride-sharing candidate.

FIG. 6 is an example of a flowchart illustrating the flow of a matching process at the time of ticket purchase according to the first embodiment. The matching process illustrated as an example in FIG. 6 includes a process in which the server 1 accepts, from a ticket purchaser, purchase of a ticket and registration of information on a ride-sharing usage pattern, and selects a ride-sharing candidate and presents the ride-sharing candidate to the ticket purchaser. The matching process illustrated as an example in FIG. 6 also includes a process in which a ticket purchaser makes a request for ride-sharing to a ride-sharing candidate. The start of the matching process is triggered by, for example, ticket purchase by a ticket purchaser.

In S11, the acceptance unit 101 acquires purchaser information input to the terminal 2 by a ticket purchaser via the communication interface 14. The purchaser information includes, for example, information, such as a name, an address, and contact information of the purchaser. The acceptance unit 101 stores the acquired purchaser information in the purchaser information table.

In S12, the acceptance unit 101 accepts purchase of a ticket for an event from the terminal 2 and acquires information on a ride-sharing usage pattern for the ticket purchaser. The information on the usage pattern for the ticket purchaser is input at the terminal 2 by the ticket purchaser. The acceptance unit 101 associates the ticket purchaser with the event, a ticket for which is purchased, and stores the information on the ride-sharing usage pattern in the ride-sharing information table.

In S13, the selection unit 102 judges whether the ticket purchaser desires ride-sharing. The selection unit 102 can judge that the ticket purchaser desires ride-sharing if the ride-sharing-usage-pattern field has “DESIRE FOR RIDE-SHARING: YES” in the ride-sharing information table. The selection unit 102 can also judge that the ticket purchaser does not desire ride-sharing if the ride-sharing-usage-pattern field has “DESIRE FOR RIDE-SHARING: NO.” If the ticket purchaser desires ride-sharing (YES in S13), the process advances to S14. If the ticket purchaser does not desire ride-sharing (NO in S13), matching for the ticket purchaser is not executed, and the process illustrated in FIG. 6 ends.

In S14, the selection unit 102 selects a ride-sharing candidate which conforms to the usage pattern for the ticket purchaser. The selection unit 102 refers to the ride-sharing information table and extracts a purchaser (purchasers) which is (are) associated with the event, a ticket for which is purchased by the ticket purchaser. Note that the selection unit 102 may also extract a purchaser (purchasers) which is (are) associated with an event similar to the event. The selection unit 102 selects, from among the extracted purchaser(s), a ride-sharing candidate which conforms to the usage pattern for the ticket purchaser. More specifically, if the ticket purchaser desires ride-sharing, the selection unit 102 selects, from among the extracted purchaser(s), a purchaser which desires ride-sharing as a ride-sharing candidate. Additionally, the selection unit 102 may select a ride-sharing candidate which is capable of vehicle provision if, for example, the ticket purchaser is incapable of vehicle provision. The selection unit 102 may select a ride-sharing candidate which is capable of driving if the ticket purchaser is incapable of driving.

A specific example in which a ride-sharing candidate is selected for a purchaser with a purchaser ID of “U002” (hereinafter referred to as a purchaser U002) in the example in FIG. 5 will be described here. The purchaser U002 has a purchased ticket for the event E02. For this reason, the selection unit 102 extracts a purchaser U004 and a purchaser U005 which are associated with the event E02 or a similar event (the event E04 in FIG. 5) from the ride-sharing information table. A usage pattern for the purchaser U002 is to desire ride-sharing, be capable of vehicle provision, and be capable of driving. Thus, the purchaser U005 that has a purchased ticket for the similar event E04 and desires ride-sharing is selected as a ride-sharing candidate which conforms to the usage pattern for the purchaser U002. As described above, the selection unit 102 can select a ride-sharing candidate which conforms to a usage pattern for a ticket purchaser in accordance with the usage pattern for the ticket purchaser.

The example in FIG. 5 illustrates an example in which a ride-sharing candidate which conforms to a usage pattern indicating the capability of vehicle provision and the capability of driving is selected, but the present disclosure is not limited to this. A ride-sharing candidate which conforms to a ride-sharing usage pattern for a ticket purchaser may be, for example, selected from among different ticket purchasers which desire to accept a ride partner if the ticket purchaser desires to be given a ride for ride-sharing and selected from among different ticket purchasers which desire to be given a ride for ride-sharing if the ticket purchaser desires to accept ride-sharing.

In S15, the presentation unit 103 presents the ride-sharing candidate selected in S14 to the ticket purchaser. The presentation unit 103 refers to the purchaser information table and can acquire purchaser information, such as a name and contact information, of the ride-sharing candidate. The presentation unit 103 can present the ride-sharing candidate to the ticket purchaser by transmitting the acquired purchaser information of the ride-sharing candidate to the terminal 2 of the ticket purchaser. Note that, if there are a plurality of ride-sharing candidates, the presentation unit 103 may present a predetermined number of (e.g., 10) candidates.

In S16, the ride-sharing acceptance unit 104 accepts a request for ride-sharing with the ride-sharing candidate from the ticket purchaser. If a plurality of ride-sharing candidates are presented as ride-sharing candidates, the ticket purchaser can select any of the candidates and make a request for ride-sharing.

In S17, the ride-sharing acceptance unit 104 notifies the terminal 2 of the candidate that is a target for the request for ride-sharing in S16 of the request for ride-sharing. The ride-sharing acceptance unit 104 may acquire purchaser information, such as contact information, of the ticket purchaser from the purchaser information table and transmit the purchaser information, in addition to the notification of the request for ride-sharing.

In S18, the ride-sharing acceptance unit 104 judges whether notification of approval for the request for ride-sharing is received from the terminal 2 of the ride-sharing candidate. If notification of approval for the request for ride-sharing is received (YES in S18), the process advances to S19. If notification of approval for the request for ride-sharing is not received (NO in S18), the process returns to S14. After the return to S14, the selection unit 102 may exclude the candidate that has not approved the request for ride-sharing and newly select a ride-sharing candidate.

In S19, the ride-sharing acceptance unit 104 notifies the terminal 2 of the ticket purchaser of the approval for the request for ride-sharing, and the matching process illustrated in FIG. 6 ends.

According to the first embodiment, a ticket purchaser which is to purchase a ticket for an event can search for a ride-sharing partner which conforms to a usage pattern for the ticket purchaser itself among different ticket purchasers for the same event or a similar event, in addition to ticket purchase. Since the time and trouble of arranging for ride-sharing separately from ticket purchase is saved, vehicle ride-sharing can be promoted.

[Modifications]

The above-described first embodiment describes an example in which candidate selection is performed on the basis of whether a ticket purchaser for an event desires ride-sharing at the time of selection of a ride-sharing candidate by the selection unit 102. In contrast, modifications are examples in which ride-sharing candidates are further narrowed down on the basis of places of departure for a ticket purchaser and the ride-sharing candidates.

(First Modification)

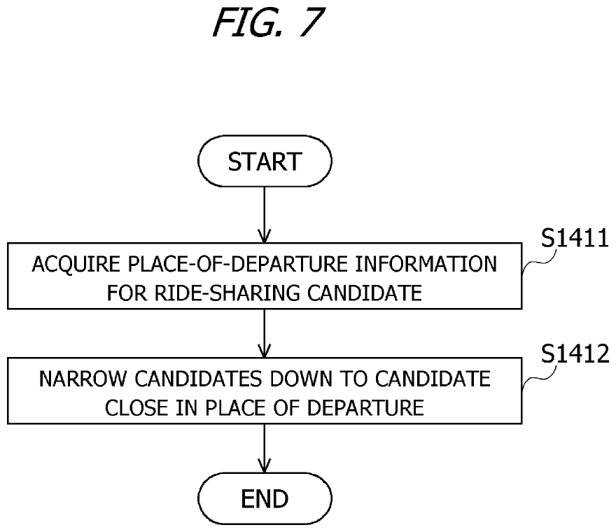

A first modification is an example in which ride-sharing candidates are narrowed down on the basis of distances between a place of departure for a ticket purchaser and places of departure for ride-sharing candidates. In the first modification, the selection unit 102 executes a ride-sharing candidate narrowing-down process illustrated in FIG. 7, in addition to the process in S14 of the matching process illustrated in FIG. 6.

FIG. 7 is an example of a flowchart illustrating the flow of a ride-sharing candidate narrowing-down process according to the first modification. In S1411, the selection unit 102 acquires, from a ride-sharing information table, information on places of departure for ride-sharing candidates selected in S14 of FIG. 6. In S1412, the selection unit 102 narrows the ride-sharing candidates selected in S14 of FIG. 6 down to ride-sharing candidates, such that a distance between a place of departure for a ticket purchaser and a place of departure for each of the ride-sharing candidates is not more than a predetermined threshold.

In S15 of FIG. 6, the presentation unit 103 may present the ride-sharing candidates in increasing order of the distances between the place of departure for the ticket purchaser and the places of departure for the ride-sharing candidates. Since a ride-sharing candidate, a distance between places of departure for which is not more than the predetermined threshold, is presented in the first modification, a ticket purchaser can save the time and trouble of searching for a ride partner which is close in place of departure and easy to meet.

(Second Modification)

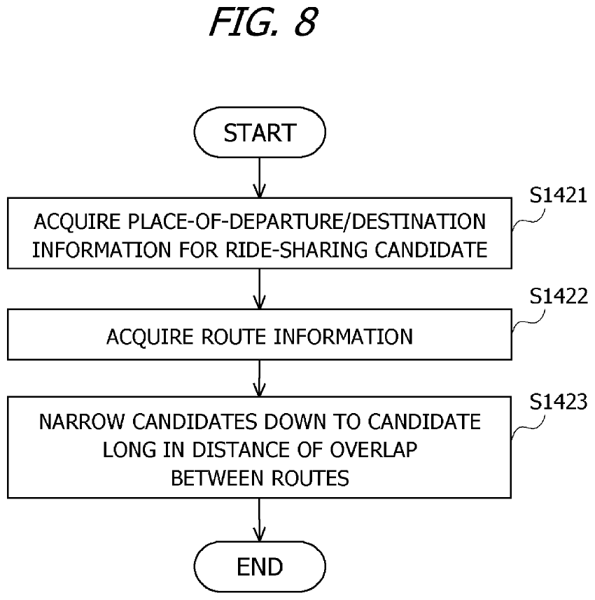

A second modification is an example in which ride-sharing candidates are narrowed down on the basis of distances of overlap between a route for a ticket purchaser to a destination and routes for the ride-sharing candidates. In the second modification, the selection unit 102 executes a ride-sharing candidate narrowing-down process illustrated in FIG. 8, in addition to the process in S14 of the matching process illustrated in FIG. 6.

FIG. 8 is an example of a flowchart illustrating the flow of a ride-sharing candidate narrowing-down process according to the second modification. In S1421, the selection unit 102 acquires, from a ride-sharing information table, information on places of departure and destinations for ride-sharing candidates selected in S14 of FIG. 6. In S1422, the selection unit 102 acquires route information for a ticket purchaser and the ride-sharing candidates from the information on the places of departure and the destinations. For example, information on ones, through which a route from a place of departure to a destination passes, among relay points defined in advance, such as parking areas, can be set as route information. In S1423, the selection unit 102 compares a route for the ticket purchaser with routes for the ride-sharing candidates and narrows the ride-sharing candidates down to ones, the degrees of overlap between routes for which are not less than a predetermined threshold. For example, the selection unit 102 can set, as the degree of overlap, the percentage of the number of ones on a route for a ride-sharing candidate of relay points on the route for the ticket purchaser.

In S15 of FIG. 6, the presentation unit 103 may present the ride-sharing candidates in decreasing order of the degrees of overlap between the route for the ticket purchaser and the routes for the ride-sharing candidates. Since a ride-sharing candidate, the degree of overlap between routes from places of departure to destinations for which is not less than the predetermined threshold, is presented in the second modification, a ticket purchaser can efficiently search for a ride partner which allows inhibition of useless detouring.

### Second Embodiment

In the first embodiment, a ride-sharing candidate is presented on the basis of whether a ticket purchaser for an event desires ride-sharing. In contrast, in a second embodiment, a ride-sharing candidate corresponding to conditions desired for a ride partner by a ticket purchaser is presented.

A configuration of the second embodiment is almost the same as that of the first embodiment and is different in data structures of a purchaser information table and a ride-sharing information table. Differences from the first embodiment will be chiefly described below.

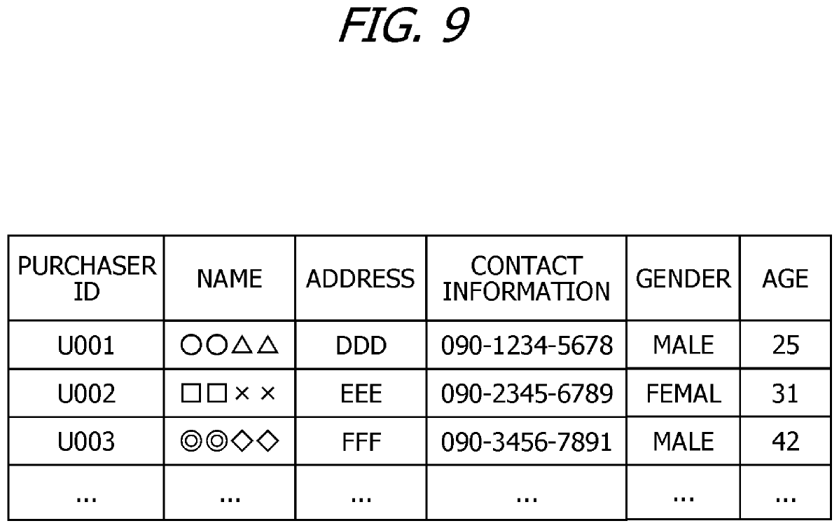

FIG. 9 is an example of a diagram illustrating a purchaser information table according to the second embodiment. The purchaser information table according to the second embodiment has fields for gender and age, in addition to the fields illustrated in the purchaser information table (FIG. 4) according to the first embodiment. The gender and the age are the gender and the age of a ticket purchaser which has a purchased ticket or a ride-sharing candidate and are information pieces (hereinafter also referred to as attribute information pieces) indicating attributes of a purchaser. Attribute information pieces are not limited to a gender and an age and may include various information pieces, such as a family structure, a hobby, and an occupation. Fields corresponding to attributes may be added to the purchaser information table. An acceptance unit 101 can acquire attribute information pieces of a purchaser from information input to a terminal 2 and store the attribute information pieces in the purchaser information table illustrated in FIG. 9. Note that the acceptance unit 101 may acquire an attribute information piece, such as a gender or an age, by analyzing a picked-up image of the purchaser which is shot by a camera or the like installed in the terminal 2.

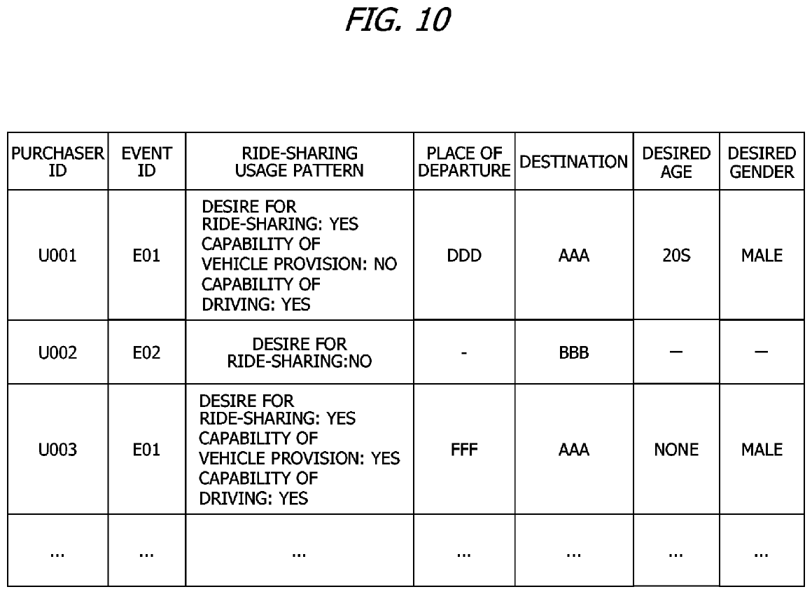

FIG. 10 is an example of a diagram illustrating a ride-sharing information table according to the second embodiment. The ride-sharing information table according to the second embodiment has fields for desired age and desired gender, in addition to the fields illustrated in the ride-sharing information table (FIG. 5) according to the first embodiment. The desired age and the desired gender are a partner age and a partner gender desired for a ride-sharing partner. Desired conditions are not limited to an age and a gender and may include various attribute information pieces. Fields to store desired conditions for attributes may be added to the ride-sharing information table. The acceptance unit 101 acquires conditions desired for a ride-sharing partner from information input to the terminal 2 and stores the conditions in the ride-sharing information table illustrated in FIG. 10, when a ticket purchaser purchases a ticket.

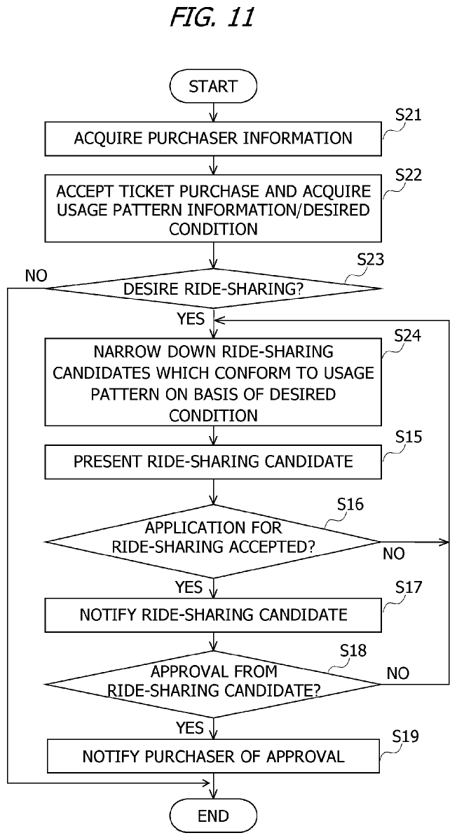

FIG. 11 is an example of a flowchart illustrating the flow of a matching process at the time of ticket purchase according to the second embodiment. Since processes in and after S15 are the same as those in the matching process illustrated in FIG. 6, processes before S15 will be described.

In S21, the acceptance unit 101 acquires purchaser information input to the terminal 2 by a ticket purchaser which is to purchase a ticket for an event via a communication interface 14, as in S11 of FIG. 6. The purchaser information may include attribute information pieces, such as the gender and the age of the purchaser, in addition to information, such as a name, an address, and contact information of the purchaser. The acceptance unit 101 stores the acquired purchaser information in the purchaser information table.

In S22, the acceptance unit 101 accepts purchase of a ticket for an event from the terminal 2, as in S12 of FIG. 6. At the same time, the acceptance unit 101 acquires desired conditions on ride-sharing for the ticket purchaser. The desired condition on ride-sharing are included in information on a ride-sharing usage pattern and are input at the terminal 2 by the ticket purchaser. The acceptance unit 101 associates the ticket purchaser with the event, a ticket for which is purchased, and stores information on the desired conditions on ride-sharing in the ride-sharing information table.

In S23, a selection unit 102 judges whether the ticket purchaser desires ride-sharing, as in S13 of FIG. 6. If the ticket purchaser desires ride-sharing (YES in S23), the process advances to S24. If the ticket purchaser does not desire ride-sharing (NO in S23), matching for the ticket purchaser is not executed, and the process illustrated in FIG. 11 ends.

In S24, the selection unit 102 selects ride-sharing candidates which conform to the usage pattern for the ticket purchaser. The selection unit 102 refers to the ride-sharing information table and extracts purchasers which are associated with the event, a ticket for which is purchased by the ticket purchaser, as in S14 of FIG. 6. Note that the selection unit 102 may also extract purchasers which are associated with an event similar to the event. The selection unit 102 selects, from among the extracted purchasers, ride-sharing candidates which conform to the usage pattern for the ticket purchaser. The selection unit 102 narrows the selected ride-sharing candidates down to ride-sharing candidates which satisfy attribute information conditions desired as to attributes of a ride partner by the ticket purchaser. More specifically, the selection unit 102 narrows the extracted purchasers down to purchasers which satisfy a desired age and a desired gender for a ride partner for the ticket purchaser.

An example in which ride-sharing candidates conforming to a usage pattern are selected for a purchaser U003 and are narrowed down to ride-sharing candidates which satisfy desired conditions in the example in FIG. 10 will be described here. The purchaser U003 has a purchased ticket for an event E01, and the usage pattern for the purchaser U003 is to desire ride-sharing, be capable of vehicle provision, and be capable of driving. Attribute information conditions desired for a ride partner by the purchaser U003 are that no particular age is desired and that a desired gender is male. Thus, a purchaser U001 which has a purchased ticket for the event E01 and desires ride-sharing is first selected as a ride-sharing candidate which conforms to the usage pattern for the purchaser U003. Since the purchaser U001 is male, as illustrated in the purchaser information table in FIG. 9, the purchaser U001 satisfies the attribute information conditions desired by the purchaser U003 and is selected as a ride-sharing candidate. Note that although an age and a gender are described as examples of an attribute information piece in FIGS. 9 to 11, the present disclosure is not limited to these. A ride-sharing candidate which satisfies conditions on various attribute information pieces, such as a family structure, a hobby, and an occupation, may be selected. Processes in and after S15 are the same as those in the matching process illustrated in FIG. 6.

According to the second embodiment, a ticket purchaser which is to purchase a ticket for an event can search for a ride-sharing partner corresponding to desired conditions among different ticket purchasers for the same event or a similar event, in addition to ticket purchase. This enhances motivation for ride-sharing of a ticket purchaser and allows promotion of vehicle ride-sharing.

### Other Embodiments

The embodiment described above is an example, and the present disclosure may be changed and carried out as appropriate without departing from the gist of the present disclosure. The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising:
a processor configured to:
accept purchase of a ticket for an event from a first ticket purchaser and, when the first ticket purchaser is to travel to a venue for the event by a vehicle, accept registration of information on a ride-sharing usage pattern;
select, as a ride-sharing candidate, a second ticket purchaser which conforms to the ride-sharing usage pattern for the first ticket purchaser from among ticket purchasers which have purchased tickets for the event or a similar event partially identical in venue and period to the event; and
present the second ticket purchaser to the first ticket purchaser.

2. The information processing apparatus according to claim 1, wherein
the second ticket purchaser is selected from among the ticket purchasers which desire to accept a ride partner if the first ticket purchaser desires to be given a ride for ride-sharing and is selected from among the ticket purchasers which desire to be given a ride for ride-sharing if the first ticket purchaser desires to accept ride-sharing.

3. The information processing apparatus according to claim 1, wherein
the processor is configured to
acquire information on a place of departure for the first ticket purchaser and narrowing down the second ticket purchaser on the basis of the acquired information on the place of departure.

4. The information processing apparatus according to claim 3, wherein
the processor is configured to
narrow down the second ticket purchaser such that a distance between the place of departure for the first ticket purchaser and a place of departure for the second ticket purchaser is equal to or less than a predetermined threshold.

5. The information processing apparatus according to claim 3, wherein
the processor is configured to
narrow down the second ticket purchaser such that the degree of overlap between a first route from the place of departure for the first ticket purchaser to the venue for the event and a second route from the place of departure for the second ticket purchaser to the venue for the event is equal to or more than a predetermined threshold.

6. The information processing apparatus according to claim 1, wherein
the processor is configured to
narrow down the second ticket purchaser such that the second ticket purchaser satisfies an attribute information condition desired by the first ticket purchaser.

7. The information processing apparatus according to claim 6, wherein
the processor is configured to
analyze a picked-up image of the second ticket purchaser and acquire an attribute information piece of the second ticket purchaser.

8. The information processing apparatus according to claim 1, wherein
the processor is configured to
accept a request for ride-sharing with the second ticket purchaser from the first ticket purchaser and transmit details of the request to a terminal of a target candidate which is a target for the request.

9. An information processing method for causing a computer to execute:
accepting purchase of a ticket for an event from a first ticket purchaser and, when the first ticket purchaser is to travel to a venue for the event by a vehicle, accepting registration of information on a ride-sharing usage pattern;
selecting, as a ride-sharing candidate, a second ticket purchaser which conforms to the ride-sharing usage pattern for the first ticket purchaser from among ticket purchasers which have purchased tickets for the event or a similar event partially identical in venue and period to the event; and
presenting the second ticket purchaser to the ticket purchaser.

10. A non-transitory computer-readable medium recorded with a program for causing a computer to execute the information processing method according to claim 9.
